(19) United States
(12) Patent Application Publication
(10) Pub. No.: US 2007/0261031 A1
(43) Pub. Date: Nov. 8, 2007

(54) Apparatus and method for encoding the execution of hardware loops in digital signal processors to optimize offchip export of diagnostic data

(76) Inventors: Ganesh M. Nandyal, Bangalore (IN); Bryan J. Thome, Houston, TX (US)

Correspondence Address: TEXAS INSTRUMENTS INCORPORATED, P O BOX 655474, M/S 3999, DALLAS, TX, 75265, US

(21) Appl. No.: 11/640,043

(22) Filed: Dec. 15, 2006

Related U.S. Application Data
(60) Provisional application No. 60/798,510, filed on May 8, 2006.

(51) Int. Cl. G06F 9/44

(52) U.S. Cl. 717/128

(57) ABSTRACT

In order to provide an export of trace data related to a block repeat instruction, a trace unit, upon identification of a group of packets applied thereto which are an instruction block that is to be repeated, forwards all the packets comprising the instruction block to a trace export unit. The trace unit saves a portion of the block instruction that permits the identification of the block instruction. When a next of the block instructions being repeated is identified, the trace unit compares the stored portion of the block instruction with the equivalent portion in the newly received block instruction. When the portions are the same, only the header packet of the block instruction is forwarded to the host processing unit. According to another embodiment of the present invention, a preselected number of complete instruction blocks are forwarded to the host processing unit before the trace unit forwards only the header packet.

This application claims the benefit of Provisional Application Ser. No. 60/798,510, entitled “A Method for Encoding the Execution of Hardware Loops in Digital Signal Processor (DSP) Such the Export of This Information Offchip is Optimized”, filed on May 26, 2006.

### BACKGROUND OF THE INVENTION

1. Field of the Invention

This invention relates generally to the test and debug of semiconductor chips, and more particularly, to reducing the amount of information that is transferred from the semiconductor chip to the host computer. The invention relates to the BlockRepeat process in which a particular instruction is repeated multiple times. This BlockRepeat process is most closely identified with hardware loop activity in digital signal processors.

2. Background of the Invention

As microprocessors and digital signal processor have become faster and more complex, the visibility and control of the system upon which software programs are being developed have become more difficult. With today's high speed processors, an enormous amount of data is generated in each clock cycle. This information needs to be captured and exported to the host computer in order to have complete visibility to the execution of the program sequence. Because of the number of signals that must applied to and received from the semiconductor chip, the number of pins that can be devoted to the export of test and debug data is severely limited.

Referring to FIG. 1, a block diagram of a test and debug apparatus relevant to the present invention is illustrated. On the semiconductor chip 10 having the processor 110 under test, the trace set-up apparatus 111 includes components coupled to the processing unit that can apply signals to the processor 110 under test, thereby establishing preselected initial conditions. The trace capture and encoding unit 112 receives signals from process or 110 and encodes the captured data in a format that will be suitable for transfer from the semiconductor chip 11. The trace export unit 113 provides the interface of the semiconductor chip for the exchange of signal groups to and from the semiconductor chip 10. The trace receiver 12 provides an interface between the semiconductor chip 11 and the host processing unit 13 for the transfer of test and debug signal groups. In the host processing unit 13, the test and debug signal groups are decoded by trace decode unit 132 into a format suitable for processing by the host processing unit 13. The test and debug signal groups are then processed and displayed by trace display 131 in such a manner as to permit identification of errors in the execution of a program.

Referring to FIG. 2, an example of the information carried by each block instruction of the sequence of BlockRepeat process is shown.

P0 is the first packet in the series and is called the BlockRepeat header packet. The encoding in this packet is as follows. Bits B9:B3=0000001 indicates a repeat. B2:B1=indicates the level of the block repeat, “10” indicating an outer loop and “01” indicating an inner loop. B0=1indicates that the last instruction of the block repeat is an instruction that is repeated by a single repeat instruction.

The packets P1 and P2 carry the instruction count from the last good known “synchronization” point of the software. This synchronization point can be series of 2 8-bit values with the 2^{nd} packet being optional and exported only when the count is greater than 256.

The packets P3:P4:P5 carry the address of the first instruction, also called the top of the block in three bytes with P3 carrying the least significant byte and P5 carrying the most significant byte.

Because the number of bits required to be exported for every iteration of the BlockRepeat instruction is very large, the amount of bandwidth required to export all the information from the chip is extremely high. This large bandwidth requirement can result in a either a loss of data, a requirement for increased on-chip storage apparatus for temporary storage of the data, or a requirement for an increase in the number of pins dedicated to the export of trace information.

A need has therefore been felt for apparatus and an associated method having the feature that exported trace information relating to the execution of a BlockRepeat process is reduced. It is yet another feature of the apparatus and associated method to provide a compression scheme the export of trace information for a BlockRepeat process. It is still another feature of the apparatus and associated method to provide to the host processor unit at least one complete instruction block that is being repeated and, thereafter to transmit only the header of the instruction packet block.

### SUMMARY OF THE INVENTION

The foregoing and other features are accomplished, according the present invention, by identifying the block of packets that form a block instruction and that is to be repeated. The first iteration of the block instruction is forwarded to the host processing unit while a selected portion of the block instruction is stored by a trace unit. When the next iteration of the block repeat instruction is applied to the trace unit, the stored portion of the first iteration of the block instruction is compared with the equivalent portion of the new iteration of the block instruction. When the portions are the same, only the header of the block instruction need be forwarded to the host processing unit. According to another embodiment of the invention, a preselected number of iterations must be identified and forwarded to the host processing unit before transmitting only the header packet. Upon identification of the new synchronization point or an exception procedure, the process is initialized and awaits the next block instruction.

Other features and advantages of present invention will be more clearly understood upon reading of the following description and the accompanying drawings and the claims.

### BRIEF DESCRIPTION OF THE DRAWINGS

FIG. 1 is a block diagram of apparatus used the test and debug of semiconductor chip according to the prior art.

FIG. 2 illustrates the packets of a simple block-instruction according to the prior art.

FIG. 3 is a block diagram of the apparatus capable of implementing a BlockRepeat process according to the present invention.

FIG. 4 is a state machine capable of implementing the BlockRepeat instruction according to the present invention.

### 1. DETAILED DESCRIPTION OF THE FIGURES

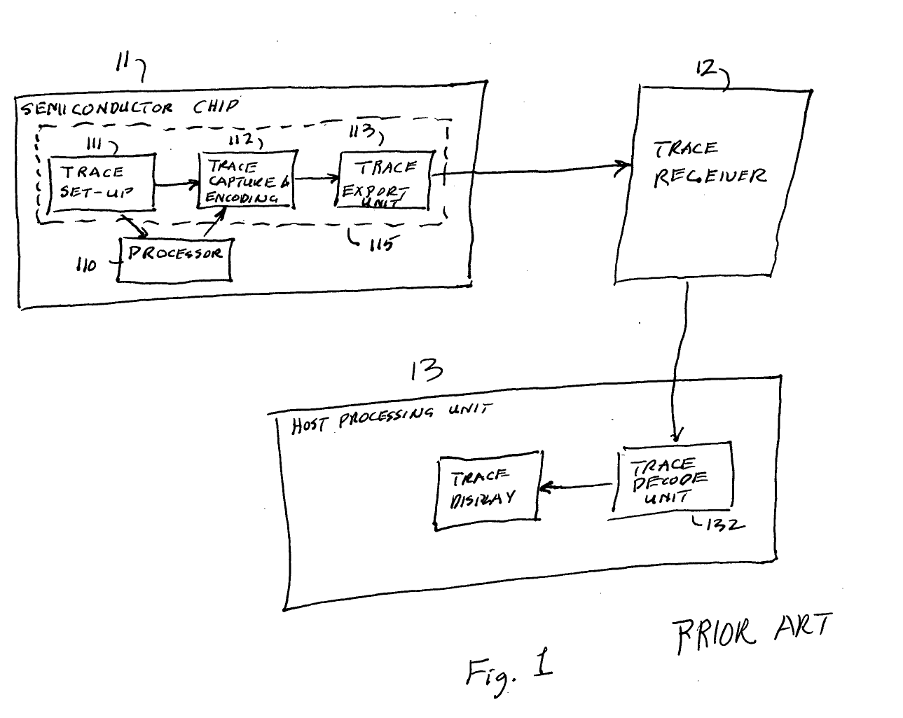

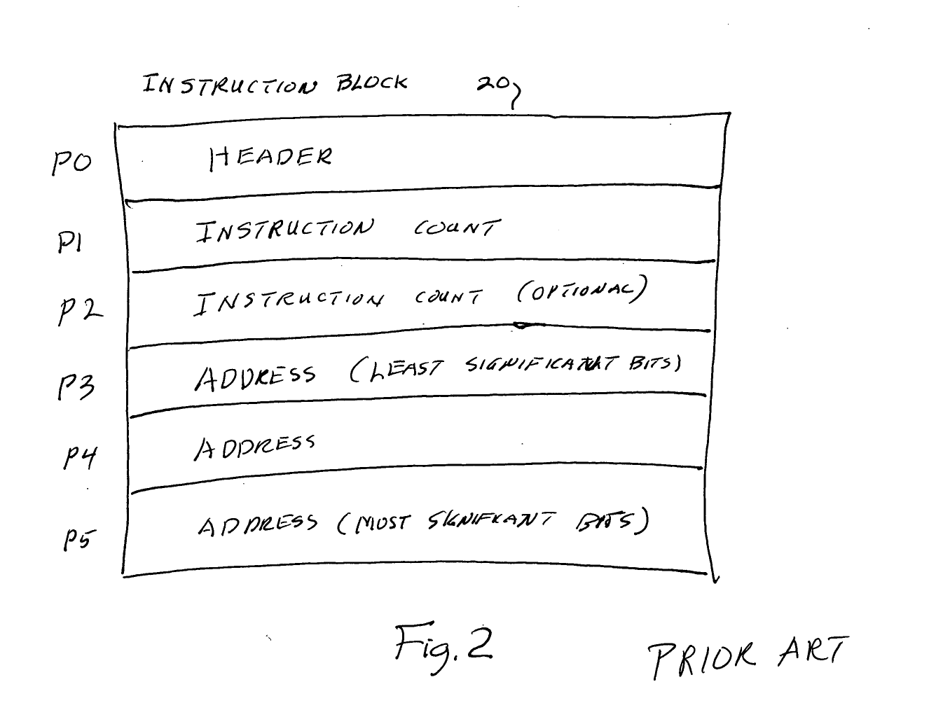

FIG. 1 and FIG. 2 have been described with respect to the related art.

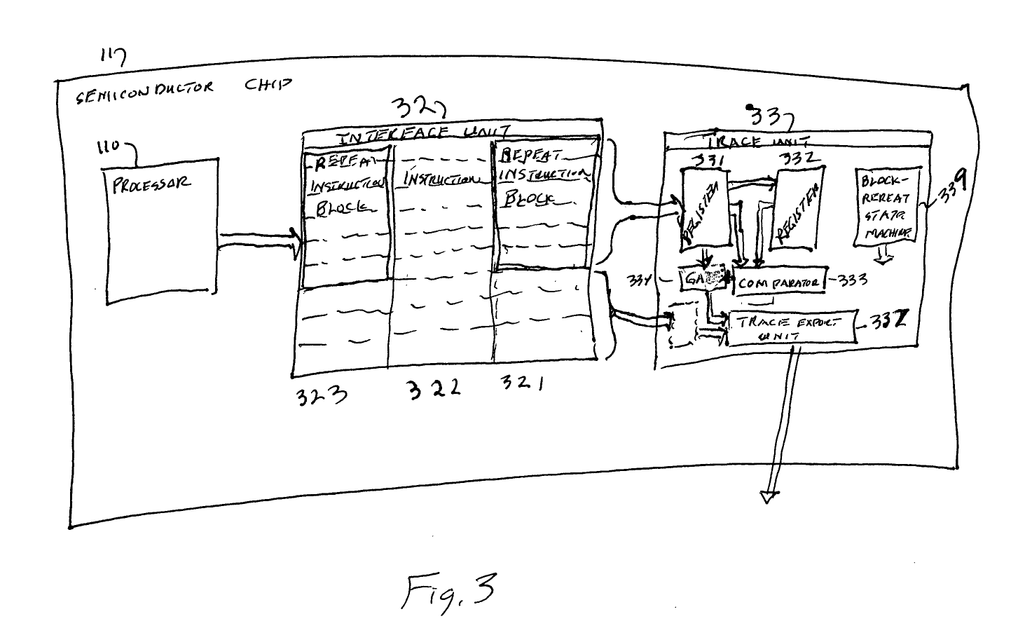

Referring to FIG. 3, a block diagram of the apparatus on semiconductor chip 30 for exporting the trace information of a BlockRepeat instruction, according to present invention, is shown. Selected components in the processor 31 (under test) provide trace signals that are applied to the interface unit 32. The interface unit 32 receives trace signals that identify instruction in the order in which the instructions are executed. (In Texas Instruments Incorporated apparatus, such a device is frequently referred to a pipeline flattener, the name indicating that, because of differing execution times, the executed instruction must be reassembled in the order in which they are executed in order to account for differing execution times.) Each instruction is entered in order into the trace unit 33. Focusing on the BlockRepeat process, after an event signifying a new block instruction sequence, the first member, i.e., the six packets of the first block instruction are transferred to the register bank 331 and then, through gate 334 to the trace export unit 331 for transfer to the host processing unit 13 (FIG. 1). The presence of the BlockRepeat instruction header packet causes the header packet and the address packets of the block instruction being repeated to be stored in a register bank 333. Thereafter, each group of packets of a block instruction in the interface unit 32 that are transferred to register 331 has the signals in positions of the header packet and the signals in the positions of the address packets being compared by comparison unit 334 with the signals stored in similar positions of the register 331. When the signals are the same, a block instruction in the BlockRepeat process is identified.

As a result, in one embodiment of the present invention, only the header signal group is forwarded to the trace export unit. This forwarding of only the header packet continues until the header packet and the address packets are not the same and/or an exception event has occurred. The process then begins again with the storage of the new header packet and the new address packets in the register 331.

In the foregoing description, only one iteration of the block instruction is required for the forwarding of only the header packet. For practical reasons, two or more complete blocks instructions must be identified and forwarded to the trace export unit before only the header packet of the block instruction is transmitted.

In addition, in the foregoing description, the block instruction has been emphasized. When the packets of the BlockRepeat process are forwarded to the trace unit, other trace signals will also be forwarded. For example, the value of the program counter is provided to the host processing unit, but other values may also be provided along with the packets of the block instruction.

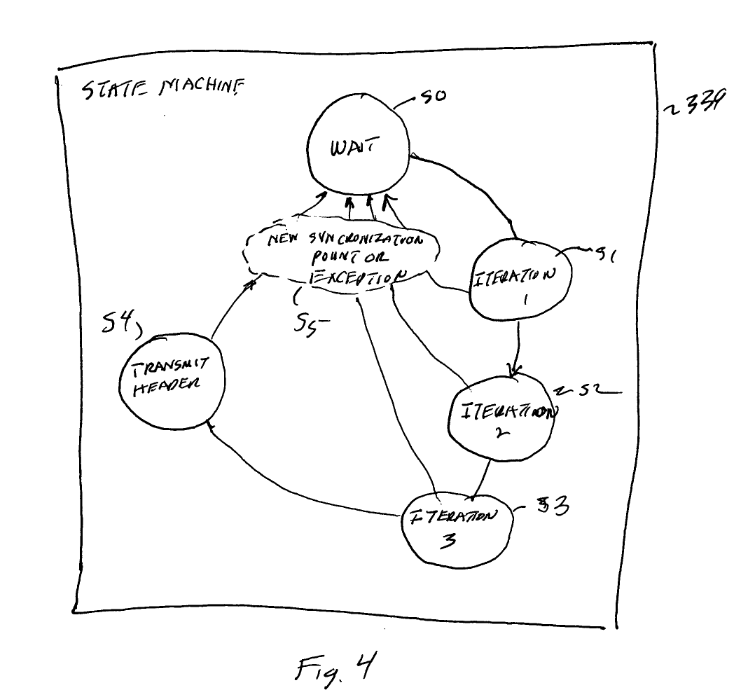

Referring to FIG. 4, the possible states of a BlockRepeat state machine is illustrated. In the illustrated state machine, three iteration of the transfer of a complete instruction packet compliment is needed before only the header packet of the block instruction is forwarded to the trace export unit. The state machine starts in the wait (or ready state) S0. When a block repeat instruction is identified in the interface unit, the state machine transitions to the Iteration 1 state S1 wherein all of the packets of the block instruction from the interface unit are transferred to trace export unit for eventual transmission to the host processing unit. Upon identification of a subsequent block instruction, the state machine enters state S2 and transfers all the packets of the block instruction to the trace interface unit. Upon identification of the next block instruction from the interface unit, the state machine transitions to state S3 and transfers the entire group of packets for the block of instructions received from the interface unit to the trace export unit. Upon identification of the next block instruction, the state machine transitions to the state S4. In state S4, only the packet containing the header information of the block instruction that has been executed is forwarded to the trace export unit. The state machine stays in state S4 and, in subsequent iterations of the block instruction from the interface unit, only the header packet is forwarded until a new synchronization point or exception process S5 is identified by the interface unit to the trace unit. When the synchronization point or exception process S5 is identified by the trace unit, the BlockRepeat state machine enters the state S5 and proceeds to enter the wait state S0 until the next block repeat instruction is identified and the state machine enters state S1.

### 2. OPERATION OF THE PREFERRED EMBODIMENT

The operation of the present invention can be understood as follows. When a BlockRepeat process is being executed, the group of packets forming the block instruction that is being block repeatedly executed is applied to the trace unit after each execution. For a preselected number of iterations, the entire group of packets forming the repeated block instruction is transmitted by the trace unit to the host processor. After the preselected number of executed block instructions are applied to the trace unit located on the semiconductor chip and forwarded to the host processing unit, only the header packet of the executed instruction packets is forwarded to the host processing unit.

A portion of the block instruction being repeated is stored in the trace unit and incoming block instructions are compared against this stored portion to insure that the instruction applied to the trace unit is a member of the block instruction being repeated.

The process ends when a new synchronization point and/or and exception instruction/process is generated. Thereafter, the process awaits the identification of a new instruction that is subject of a new BlockRepeat process.

While the invention has been described with respect to the embodiments set forth above, the invention is not necessarily limited to these embodiments. Accordingly, other embodiments, variations, and improvements not described herein are not necessarily excluded from the scope of the invention, the scope of the invention being defined by the following claims.

What is claimed is:

1. In a data processing system capable of repeatedly executing a block instruction, the block instruction including a plurality of signal packets; the data processing system comprising:
a processor capable of executing instructions;
trace apparatus coupled to predetermined data processing system components; and
a trace unit having executed block instruction applied thereto by the trace apparatus, the trace unit including;
a register for storing a least a first portion of the first instance of an executed block instruction
a comparator for comparing each instruction executed by the processor with the stored portion of the first instance of the block instruction; and
a trace export unit for exporting signal groups applied thereto, the comparator forwarding a portion of each addition instance of the block instruction.

2. The data processing system as recited in claim 1 wherein the first instance of the block instruction is applied to the trace export unit.

3. The data processing system as recited in claim 2 wherein after a predetermined number of instance or instances of the block instruction, only a second portion of the block instruction is applied to the trace export unit.

4. The data processing system as recited in claim 4 wherein the second portion of the block instruction is a header packet.

5. The data processing system as recited in claim 1 further comprising an interface unit coupled between the trace apparatus and the trace unit, the interface device applying the executed instructions to the trace unit is the order of execution.

6. The data processing system of claim 1 wherein the components associated with the repeated execution of a block instruction are initialized by a new synchronization point or by an exception event.

7. A method of exporting trace data by trace unit of a processing unit for a BlockRepeat instruction, the BlockRepeat instruction resulting in repeated execution of a selected instruction represented by a group of packets, the method comprising:
identifying the selected instruction after each execution of the selected instruction;
exporting all the packets selected instruction in response to the first execution of the selected instruction; and,
exporting a subset of the packet signals after the at least one execution of the selected instruction thereafter.

8. The method as recited in claim 7, wherein the selected instruction includes:
a header packet;
at least one packet identifying a synchronization point; and

9. The method as recited in claim 7 wherein the subset of signals exported is a header packet of the selected instruction.

10. The method as recited in claim 7 further comprising:
storing a portion of at least one selected instruction in the trace unit;
comparing the stored selected portion with the equivalent portion of an instruction applied to the trace unit; and
transferring at least a portion of the instruction applied to the trace unit to a host processor when the comparison is positive.

11. A trace unit for use in test and debug procedures, the trace unit comprising:
a first register, the first register receiving instructions applied to the trace unit;
a second register, the second register storing at least a portion of a first instance of a block instruction that is to be repeated;
a comparator coupled to the first and the second register, the comparator determining when a block instruction in the first register is the same block instruction having a portion stored in the first register;
a trace export unit, the trace export unit transporting trace signals to apparatus for test and debug procedures; and
a gate coupled between the first register and the trace export unit and responsive to signals from the comparator, the gate determining which block instruction signals are applied to the trace export unit.

12. The trace unit as recited in claim 11 wherein a predetermined number of instances of the block instruction are applied to the trace export unit.

13. The trace unit as recited in claim 12 wherein a predetermined number of block instruction instances are applied to the trace export unit.

14. The trace unit as recited in claim 13 wherein after the predetermined instances only a header is applied to the trace export unit.

15. The trace unit as recited in claim 11 further comprising a state machine coupled to the gate, the state machine determining the block instruction signals to be applied to the gate unit.
